(19) United States
(12) Patent Application Publication
(10) Pub. No.: US 2026/0210261 A1
(43) Pub. Date: Jul. 23, 2026

(54) GAS TURBINE ENGINE WITH A ROTOR STAGE SHROUD

(71) Applicant: Pratt & Whitney Canada Corp., Longueuil (CA)

(72) Inventors: Michael Modafferi, Brossard (CA); Remy Synnott, St-Jean-sur-Richelieu (CA)

(21) Appl. No.: 19/032,892

(22) Filed: Jan. 21, 2025

(51) Int. Cl. F01D 11/08

(52) U.S. Cl. CPC F01D 11/08; F05D 2240/11

(57) ABSTRACT

A gas turbine engine is provided that includes compressor, combustor, and turbine sections. The turbine section includes a rotor stage having a bladed rotor and a shroud. The bladed rotor includes a disk and a plurality of rotor blades extending radially outward from the disk. Each rotor blade has a leading edge and a blade tip surface. The shroud is disposed radially outside of the bladed rotor, and circumferentially around the bladed rotor. The shroud includes a primary segment (PS) and a forward segment (FS). The primary segment has a PS forward end surface and a PS inner radial surface. The forward segment is disposed forward of the rotor blades and is configured to deflect core gas flow away from a blade tip gap disposed between the PS inner radial surface and the blade tip surface of each said rotor blade of the plurality of rotor blades.

### TECHNICAL FIELD

The present disclosure relates to a gas turbine engines in general, and to gas turbine engine rotor shrouds in particular.

### BACKGROUND INFORMATION

A gas turbine shroud disposed radially outside the rotor blades of a bladed rotor is intended to minimize core gas bypassing the rotor blades during operation and thereby improve the efficiency of the rotor stage. Core gas bypassing the rotor blades in a turbine section does not perform any work on the rotor blades. A shroud that minimizes core gas bypass and thereby improves the efficiency of the rotor stage would be of significant value.

### SUMMARY

According to an aspect of the present disclosure, a gas turbine engine having an axial centerline is provided that includes a compressor section, a combustor section, and a turbine section. The turbine section includes a rotor stage having a bladed rotor and a shroud. The bladed rotor includes a disk and a plurality of rotor blades extending radially outward from the disk. Each rotor blade has a leading edge and a blade tip surface. The shroud is disposed radially outside of the bladed rotor, and extends circumferentially around the bladed rotor. The shroud includes a primary segment (PS) and a forward segment (FS). The primary segment has a PS forward end surface and a PS inner radial surface. The forward segment is disposed forward of the rotor blades and is configured to deflect core gas flow away from a blade tip gap disposed between the PS inner radial surface and the blade tip surface of each said rotor blade of the plurality of rotor blades.

In any of the aspects or embodiments described above and herein, the forward segment may have an FS inner radial surface that extends between an FS forward end surface and an FS aft end surface. The forward segment may extend from the PS inner radial surface radially inward a distance, such that the FS inner radial surface is radially aligned with blade tip surfaces of the rotor blades or disposed radially inward of the blade tip surfaces of the rotor blades.

In any of the aspects or embodiments described above and herein, the FS inner radial surface may be radially aligned with blade tip surfaces of the rotor blades at the leading edge of the respective rotor blades or may be disposed radially inward of the blade tip surfaces of the rotor blades at the leading edge of the respective rotor blades.

In any of the aspects or embodiments described above and herein, the FS forward end surface may be disposed contiguous with the PS forward end surface.

In any of the aspects or embodiments described above and herein, at least a portion of the FS forward end surface may be co-planar with the PS forward end surface.

In any of the aspects or embodiments described above and herein, the FS inner radial surface may be disposed radially inward of the blade tip surfaces of the rotor blades.

In any of the aspects or embodiments described above and herein, at least a portion of the FS inner radial surface may be disposed parallel to the axial centerline of the gas turbine engine.

In any of the aspects or embodiments described above and herein, at least a portion of the FS aft end surface may be arcuately configured.

In any of the aspects or embodiments described above and herein, a portion of the FS aft end surface may be arcuately configured and may be contiguous with the PS inner radial surface.

In any of the aspects or embodiments described above and herein, the FS inner radial surface may be a peak that is contiguous with the FS forward end surface and an FS aft end surface.

In any of the aspects or embodiments described above and herein, the shroud is a circumferentially segmented structure.

In any of the aspects or embodiments described above and herein, the gas turbine engine may include a vane stage disposed contiguous with rotor stage and axially upstream of rotor stage, wherein the vane stage includes an outer platform disposed adjacent the shroud.

According to an aspect of the present disclosure a turbine rotor stage having an axial centerline is provided that includes a bladed rotor and a shroud. The bladed rotor includes a disk and a plurality of rotor blades that extend radially outward from the disk. Each rotor blade has a leading edge and a blade tip surface. The shroud is disposed radially outside of the bladed rotor. The shroud extends circumferentially around the bladed rotor, and includes a primary segment (PS) and a forward segment (FS). The primary segment has a PS forward end surface and a PS inner radial surface. The forward segment has an FS inner radial surface that extends between an FS forward end surface and an FS aft end surface. The forward segment extends from the PS inner radial surface radially inward a distance, such that the FS inner radial surface is radially aligned with blade tip surfaces of the rotor blades or disposed radially inward of the blade tip surfaces of the rotor blades.

In any of the aspects or embodiments described above and herein, the primary segment and the forward segment may be integral with one another.

According to an aspect of the present disclosure, a turbine rotor stage having an axial centerline is provided that includes a bladed rotor and a shroud. The bladed rotor includes a disk and a plurality of rotor blades extending radially outward from the disk. Each rotor blade has a leading edge and a blade tip surface. The shroud is disposed radially outside of the bladed rotor, and extends circumferentially around the bladed rotor. The shroud includes a primary segment (PS) and a forward segment (FS). The primary segment has a PS forward end surface and a PS inner radial surface. The forward segment has an FS inner radial surface that extends between an FS forward end surface and an FS aft end surface. The forward segment extends from the PS inner radial surface radially inward a distance, such that the FS inner radial surface is disposed radially inward of the blade tip surfaces of the rotor blades.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic illustration of a gas turbine engine.

FIG. 2 is diagrammatic illustration of a vane stage and a rotor stage according to the present disclosure.

FIG. 3 is a diagrammatic cross-section of a rotor blade airfoil.

FIG. 4 is a diagrammatic illustration of a present disclosure shroud embodiment.

FIG. 4A is an enlarged view of a portion of the shroud embodiment shown in FIG. 4.

FIG. 5 is a diagrammatic partial illustration of a present disclosure shroud, illustrating a forward segment embodiment.

FIG. 5A is a diagrammatic partial illustration of a present disclosure shroud, illustrating a forward segment embodiment.

FIG. 5B is a diagrammatic partial illustration of a present disclosure shroud, illustrating a forward segment embodiment.

FIG. 5C is a diagrammatic partial illustration of a present disclosure shroud, illustrating a forward segment embodiment.

FIG. 5D is a diagrammatic partial illustration of a present disclosure shroud, illustrating a forward segment embodiment.

FIG. 5E is a diagrammatic partial illustration of a present disclosure shroud, illustrating a forward segment embodiment.

FIG. 6 is diagrammatic illustration of a vane stage and a rotor stage with core gas flow lines.

FIG. 6A is diagrammatic illustration of a vane stage and a rotor stage according to the present disclosure, with core gas flow lines.

### DETAILED DESCRIPTION

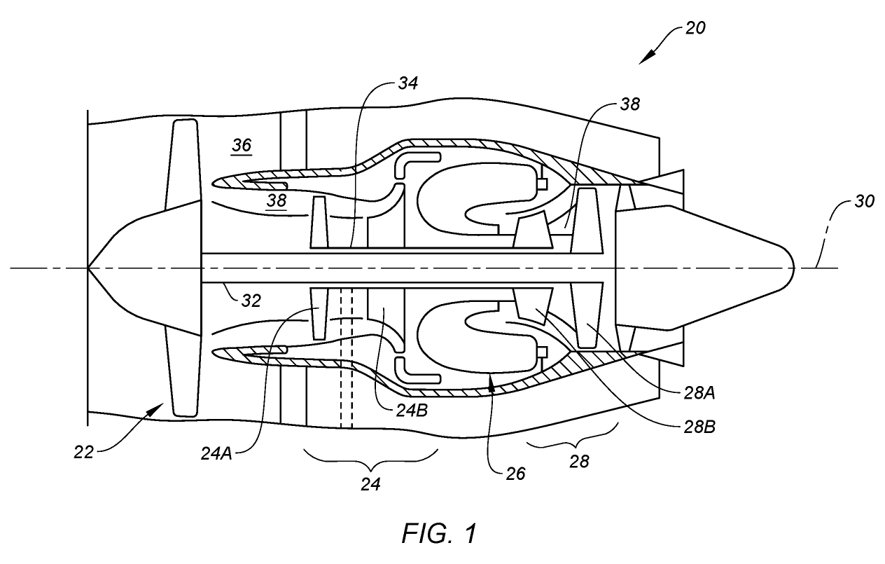

FIG. 1 diagrammatically illustrates an example of a gas turbine engine 20 that includes a fan section 22, a compressor section 24, a combustor section 26, and a turbine section 28 disposed relative to a axial centerline / rotational axis 30. The compressor section 24 includes a low pressure compressor (LPC 24A) and a high pressure compressor (HPC 24B). The turbine section 28 includes a low pressure turbine (LPT 28A) and a high pressure turbine (HPT 28B). A low speed shaft 32 connects the fan section 22, the LPC 24A and the LPT 28A. A high speed shaft 34 connects the HPC 24B and the HPT 28B. The low speed shaft 32 and the high speed shaft 34 are mounted for rotation about the axial centerline / rotational axis 30. The low speed shaft 32 may drive the fan section 22 directly or through a geared architecture; e.g., to drive the fan section 22 at a lower rotational speed than the low speed shaft 32. The LPC 24A, HPC 24B, LPT 28A, and the HPT 28B may each include one or more rotor stages and one or more stator vane stages. Air entering the engine 20 passes through the fan section 22. A first portion of the air exiting the fan section 22 enters a bypass flow path 36 and a second portion enters the engine core and travels through the core gas path 38. Air traveling within the core gas path 38 first encounters the compressor section 24 and is subsequently passed to the combustor section 26 wherein fuel is mixed with the air and is combusted. Non-combusted air and gaseous byproducts of the combustion exit the combustor section 26 and pass through the turbine section 28 before exiting the engine 20. To facilitate the description herein, air or gaseous combustion products, or any combination thereof will be referred to as “core gas” hereinafter, unless noted otherwise. Although diagrammatically shown as a turbofan in FIG. 1, the present disclosure may be used with other gas turbine engine 20 architectures such as turbojets, turboshafts, and the like. The present disclosure is not, therefore, limited to use with any particular gas turbine engine architecture.

A gas turbine engine 20 according to the present invention may be used to produce power for an aircraft or may be used in a land-based application. The aircraft may be an airplane, a helicopter, a drone (e.g., an unmanned aerial vehicle (UAV)) or any other manned or unmanned aerial vehicle or system.

The terms “forward”, “leading”, “aft”, and “trailing” are used herein to indicate the relative position of a component or surface. A “leading edge” of a rotor blade encounters core gas flow before the “trailing edge” of the same. When referring to an axial flow gas turbine engine 20 like that shown in FIG. 1, a “forward” or “upstream” component encounters core gas flow prior to an “aft” or “downstream” second component; e.g., the compressor section 24 is forward / upstream of the combustor section 26, and the turbine section 28 is aft/downstream of the combustor section 26. The terms “inner radial” and “outer radial” refer to relative radial positions from the engine 20 centerline; e.g., an inner radial component is disposed radially closer to the centerline than an outer radial component.

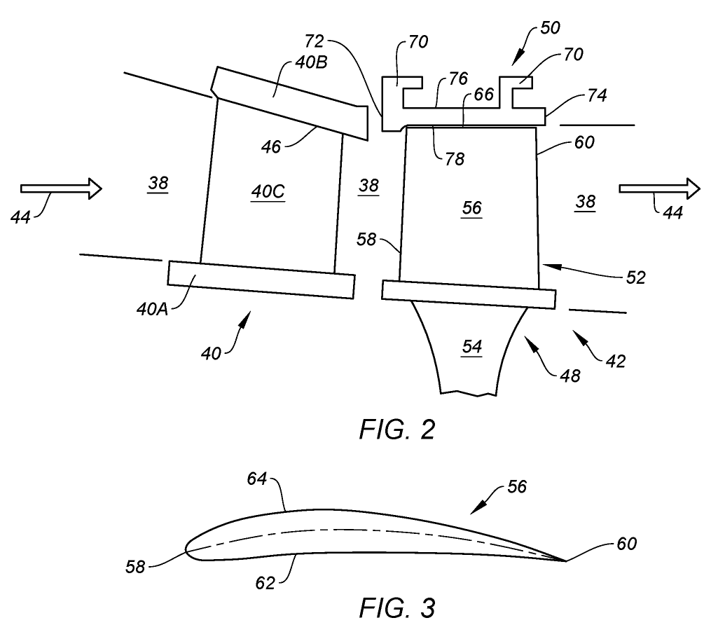

FIG. 2 diagrammatically illustrates a vane stage 40 upstream / forward of a rotor stage 42. The vane stage 40 and the rotor stage 42 may, for example, be configured for use in the LPT 28A or the HPT 28B. The direction of core gas passing through the core gas path 38 through the vane stage 40 and the rotor stage 42 is indicated by arrows 44.

The vane stage 40 is an annular structure that includes an inner platform 40A, an outer platform 40B, and a plurality of vanes 40C extending radially between the inner and outer platforms 40A, 40B. The vane outer platform 40B has an interior surface 46 that defines the outer radial boundary of the core gas path 38 through the vane stage 40.

The rotor stage 42 includes a bladed rotor 48 and a shroud 50. The bladed rotor 48 is rotatable about the engine axis 30. The bladed rotor 48 includes a plurality of rotor blades 52 extending out from and connected to a disk 54. The rotor blades 52 are arranged around the circumference of the disk 54. The rotor blades 52 may be formed integrally with the disk 54, or may be mechanically attached to the disk 54, or the like.

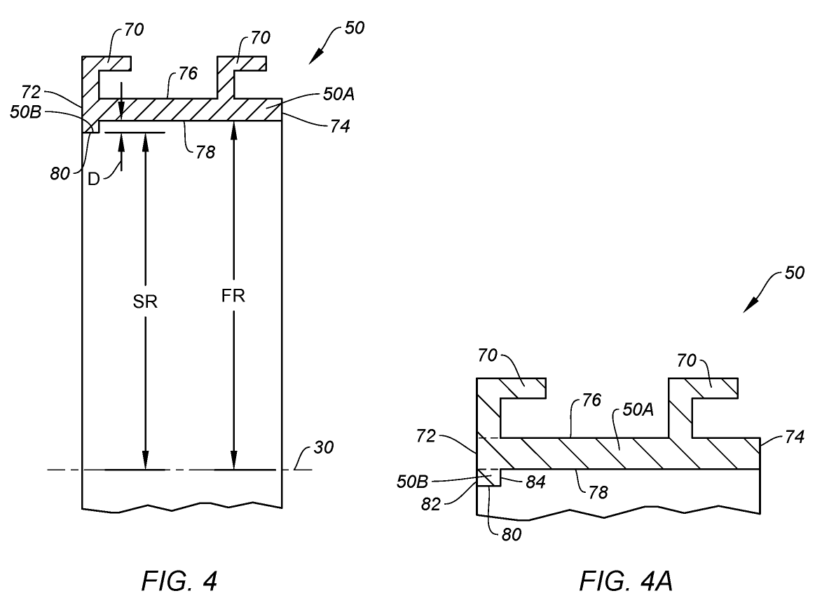

Each rotor blade 52 includes an airfoil 56 having a leading edge 58, a trailing edge 60, a pressure side surface 62, a suction side surface 64, and a blade tip surface 66. FIG. 3 diagrammatically illustrates a sectional view of an airfoil 56 to facilitate the description herein. As shown in FIG. 2, some rotor blade 52 embodiments may include an inner radial platform 68. The rotor blade 52 extends spanwise from the inner radial platform 68 to the blade tip surface 66. The rotor blade 52 extends along a camber line between the leading edge 58 and the trailing edge 60, and laterally (e.g., in a direction perpendicular to the camber line) between the pressure side surface 62 and the suction side surface 64.

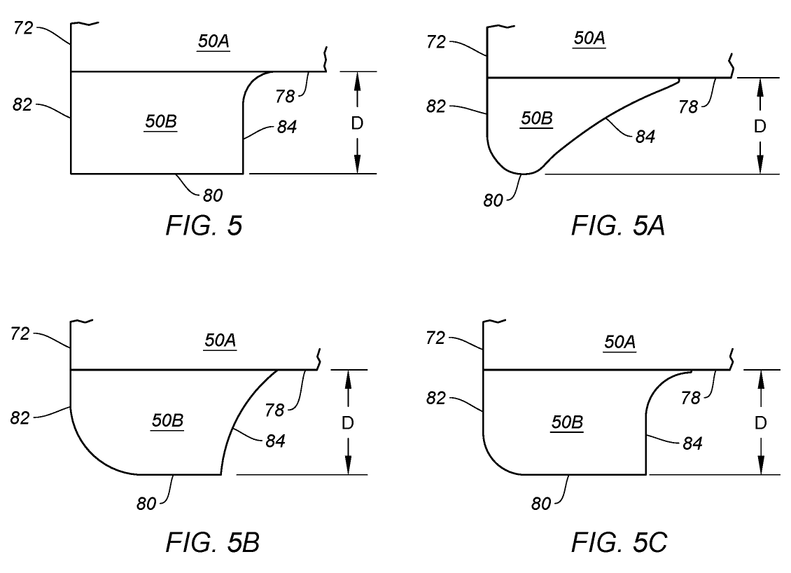

Referring to FIGS. 2, 4, and 4A, the shroud 50 is an annular structure, extending circumferentially around the bladed rotor 48. Circumferentially, the shroud 50 may be a circumferentially unitary structure or may be circumferentially segmented structure; e.g., collectively formed from a plurality of circumferential segments.

The shroud 50 includes a primary segment 50A and a forward segment 50B. The shroud 50 may include retention features 70 (e.g., see FIGS. 2, 4, and 4A) but retention features 70 are not required. When retention features 70 are included, the present disclosure is not limited to any particular retention feature 70 configuration. The primary and forward segments 50A, 50B of the shroud 50 may be integrally connected to one another; e.g., a monolithic structure, or the primary segment 50A and the forward segment 50B may be independent structures that are joined together (e.g., joined by mechanical fasteners, or by bonding, or the like) to form the shroud 50.

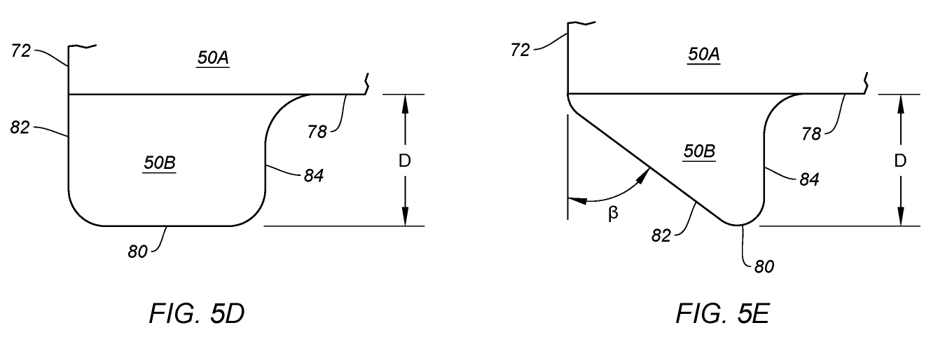

The primary segment 50A (PS) has a PS forward end surface 72, a PS aft end surface 74, a PS outer radial surface 76, and a PS inner radial surface 78. The forward segment 50B (FS) has an FS inner radial surface 80, an FS forward end surface 82, an FS aft end surface 84, and an axial length that extends between the FS forward end surface 82 and the FS aft end surface 84; e.g., see FIGS. 4A and 5-5E. At least a portion of the forward segment 50B extends radially inward from the PS inner radial surface 78 a distance “D” and is disposed at the forward end of the primary segment 50A. As will be detailed herein, the forward segment radial extension distance “D” is great enough such that the FS inner radial surface 80 is at least radially aligned with the blade tip surfaces 66 of the bladed rotor 48 adjacent the leading edge 58 (i.e., disposed at the same radius) and is preferably disposed radially inward of the blade tip surfaces 66 of the bladed rotor 48; i.e., disposed at a shorter radius. The PS inner radial surface 78 may also be described as being disposed at a first radius (FR) from the centerline / rotational axis 30, and the FS inner radial surface 80 may be described as being disposed at a second radius (SR) from the centerline / rotational axis 30, wherein the first radius is greater than the second radius; i.e., the FS inner radial surface 80 is disposed radially closer to the centerline than the PS inner radial surface 78 – see FIG. 4. Also as will be detailed herein, the forward segment 50B is disposed axially forward of the leading edge 58 of the rotor blades 52 proximate the blade tip surface 66 of the rotor blades 52. To be clear, it is noted that the relative positions of the shroud and the blade tip surfaces 66 will vary depending on the thermal status of the shroud and the bladed rotor as well as other factors. The present disclosure includes configurations wherein the forward segment radial extension distance “D” is great enough such that the FS inner radial surface 80 is at least radially aligned with the blade tip surfaces 66 of the bladed rotor 48 adjacent the leading edge 58 and preferably disposed radially inward of the blade tip surfaces 66 of the bladed rotor 48 when the engine is operating in a thermally steady-state mode of operation; e.g., during cruise, etc.

The forward segment 50B may be configured in a plurality of different cross-sectional geometries. In FIGS. 4 and 4A, the shroud 50 is shown having rectangularly shaped primary and forward segments 50A, 50B with inner radial surfaces 78, 80 that are disposed parallel to the centerline 30. The present disclosure is not limited to the primary and forward segment 50B configurations shown in FIGS. 4 and 4A. FIGS. 5-5E illustrate several examples of forward segment 50B configurations that may be used with the present disclosure. The forward segment 50B shown in FIG. 5 has an FS forward end surface 82 that is coplanar with the PS forward end surface 72, an FS inner radial surface 80 that is parallel to the axial centerline, an FS aft end surface 84 with a first portion that is parallel with the FS forward end surface 82 and a second portion that arcuately transitions to the PS inner radial surface 78. The FS inner radial surface 80 is disposed the distance “D” from the PS inner radial surface 78.

The forward segment 50B shown in FIG. 5A has an FS forward end surface 82 that is coplanar with the PS forward end surface 72 for a distance and arcuately transitions to a peak that serves as the FS inner radial surface 80. The FS aft end surface 84 arcuately extends from the peak / FS inner radial surface 80 to the PS inner radial surface 78. The peak / FS inner radial surface 80 is disposed the distance “D” from the PS inner radial surface 78.

The forward segment 50B shown in FIG. 5B has an FS forward end surface 82 that is coplanar with the PS forward end surface 72 for a distance and arcuately transitions to the FS inner radial surface 80. The FS aft end surface 84 arcuately extends from the FS inner radial surface 80 to the PS inner radial surface 78. The FS inner radial surface 80 is disposed the distance “D” from the PS inner radial surface 78.

The forward segment 50B shown in FIG. 5C has an FS forward end surface 82 that is coplanar with the PS forward end surface 72 for a distance and arcuately transitions to the FS inner radial surface 80. The FS aft end surface 84 includes a first portion that is parallel with the FS forward end surface 82 and a second portion that extends arcuately to the PS inner radial surface 78. The FS inner radial surface 80 is disposed the distance “D” from the PS inner radial surface 78.

The forward segment 50B shown in FIG. 5D has a portion of the FS forward end surface 82 that is coplanar with the PS forward end surface 72 and a second portion that arcuately transitions to the FS inner radial surface 80. An arcuate transition extends between the FS inner radial surface 80 and the FS aft end surface 84. Another arcuate transition extends between the FS aft end surface 84 and the PS inner radial surface 78. The FS inner radial surface 80 is disposed the distance “D” from the PS inner radial surface 78.

The forward segment 50B shown in FIG. 5E has an FS forward end surface 82 that is angularly disposed (e.g., at angle “β”) relative to the PS forward end surface 72, and extends from the PS forward end surface 72 to a peak that serves as the FS inner radial surface 80. The FS aft end surface 84 extends from the peak / FS inner radial surface 80 and arcuately transitions to the PS inner radial surface 78. The peak / FS inner radial surface 80 is disposed the distance “D” from the PS inner radial surface 78.

The forward segment 50B cross-sectional geometries shown in FIGS. 4-5E are provided to illustrate examples of forward segment 50B cross-sectional geometries and the present disclosure is not intended to be limited to these examples.

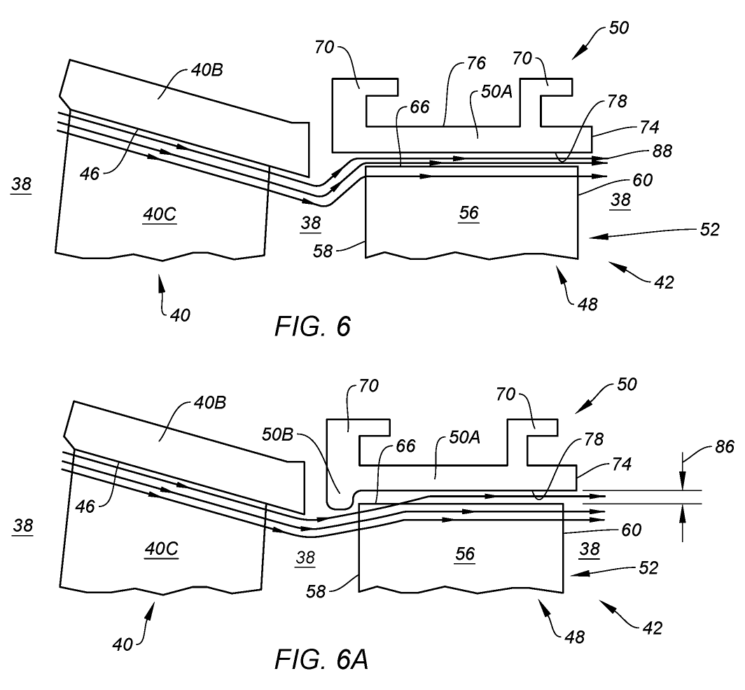

During operation of the gas turbine engine 20, core gas flow passes through the core gas path 38 and through the vane stage 40 and rotor stage 42. As the core gas flow passes through the rotor stage 42, the core gas flow encounters the rotor blades 52 of the bladed rotor 48 and causes the bladed rotor 48 to rotate. The core gas flow causing the bladed rotor 48 to rotate may be referred to as the core gas flow “performing work” on the bladed rotor 48. Any core gas flow that does not engage with the rotor blades 52 will not perform work on the bladed rotor 48 and consequently the energy transferred to the core gas flow in the compressor section 24 and the combustor section 26 is wasted. Core gas passing through the gap between the rotor blade tips and the PS inner radial surface 78 of the shroud 50 (i.e., the “blade tip gap 86”; see FIG. 6A) does not engage with the rotor blades 52 and therefore does not perform work on the rotor blades 52.

A person of skill in the art will recognize that the blade tip gap 86 can vary greatly as a result of thermal mismatch between the bladed rotor 48 and the shroud 50, or because of bladed rotor 48 centrifugal growth, or the like, or any combination thereof. Maintaining a large blade tip gap 86 is useful to prevent blade incursion into the shroud 50, but also increases the inefficiency of the rotor stage 42 because the increased blade tip gap 86 allows a greater amount of core gas flow to pass through the blade tip gap 86 without contributing work. FIG. 6 diagrammatically illustrates core gas flow in close proximity to the inner radial surface of a shroud 50, including some amount of the core gas flow (diagrammatically illustrated by flow line 88) that travels axially through the blade tip gap 86 for the entire axial length of the blade tip; i.e., from the leading edge 58 to the training edge. It should be noted that the shroud 50 shown in FIG. 6 does not include a forward segment 50B to facilitate the explanation herein. As indicated herein, core gas flow that travels axially through the blade tip gap 86 for the entire axial length of the blade tip (e.g., see flow line 88) does not perform any work on the rotor blades 52.

Embodiments of the present disclosure shroud 50 are configured to redirect core gas flow exiting the vane stage 40 radially inward and therefore away from the blade tip gap 86 for at least some axial length; i.e., the core gas flow engaging with the blade tip gap 86 is “axially delayed”. As shown in FIG. 6A, the forward segment 50B of the shroud 50 is disposed forward of the rotor blades 52, and extends radially inward a distance; i.e., the forward segment radial extension distance “D”; e.g., see FIGS. 5-5E. The distance which the shroud forward segment 50B extends radially inward from the PS inner radial surface 78 may be chosen depending on the application at hand. For example, in some applications a forward segment radial extension distance “D” may be chosen that disposes the FS inner radial surface 80 to be at least radially aligned with the blade tip surfaces 66 at the leading edges 58 of the rotor blades 52; i.e., disposed at the same radius as the blade tip surfaces 66 at the leading edges 58 of the rotor blades 52. In some applications, a forward segment radial extension distance “D” may be chosen that disposes the FS inner radial surface 80 radially inward of the blade tip surfaces 66 at the blade leading edges 58; i.e., the forward segment 50B is disposed forward of and radially overlaps (i.e., shorter radius) with a portion of the rotor blades 52 at the leading edges 58. As noted above, the relative radial positions of the shroud 50 and the rotor blade tip surfaces 66 can vary depending on engine 20 operating conditions. To facilitate the description herein, the configurations wherein the FS inner radial surface 80 of the shroud forward segment 50B is radially aligned with the blade tip surfaces 66, or is disposed radially inward of the blade tip surfaces 66 at the blade leading edges 58 refers to an operational status wherein the engine 20 is either not under power or when the engine 20 is in a steady state condition; e.g., when there is minimal or no thermal mismatch between the bladed rotor 48 and the shroud 50.

In those embodiments wherein the FS inner radial surface 80 of the shroud forward segment 50B is radially aligned with the blade tip surfaces 66, or is disposed radially inward of the blade tip surfaces 66 at the blade leading edges 58, the forward segment 50B of the shroud 50 inhibits or blocks core gas flow from entering the blade tip gap 86 at the leading edge 58 of the rotor blade 52. As shown diagrammatically in FIG. 6A, core gas flow traveling axially (forward to aft) through the rotor stage 42 may at some point drift radially outward and pass into the blade tip gap 86. Until the core gas drifts radially outward (if it does at all), that core gas flow is engaged with the rotor blades 52 where it can perform work on the rotor blades 52, thereby increasing the efficiency of the rotor stage 42.

Hence, the forward segment 50B is configured to divert core gas flow away from the blade tip gap 86 at the leading edges 58 of the rotor blades 52. As detailed herein, the present disclosure is not limited to any particular forward segment 50B cross-sectional geometry, with non-limiting examples shown in FIGS. 4-5E. It is also disclosed herein that the present disclosure rotor stage 42 and shroud 50 may be utilized in a variety of different rotor stage 42 applications (e.g., within the HPT 28B and/or within the LPT 28A). The various forward segment 50B cross-sectional geometries may be selected based on the application at hand.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms "a," "an," and "the" refer to one or more than one, unless the context clearly dictates otherwise. For example, the term "comprising a specimen" includes single or plural specimens and is considered equivalent to the phrase "comprising at least one specimen." The term "or" refers to a single element of stated alternative elements or a combination of two or more elements unless the context clearly indicates otherwise. As used herein, "comprises" means "includes." Thus, "comprising A or B," means "including A or B, or A and B," without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures--such as alternative materials, structures, configurations, methods, devices, and components, and so on--may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible.

Amendments to the Claims:

1. A gas turbine engine having an axial centerline, the gas turbine engine comprising:a compressor section;a combustor section; anda turbine section, wherein the turbine section includes a vane stage and a rotor stage, wherein the rotor stage comprises a bladed rotor and an annular shroud having a circumference;wherein the vane stage is disposed forward of and adjacent the rotor stage, and the annular shroud is independent of the vane stage; andwherein the bladed rotor includes a disk and a plurality of rotor blades extending radially outward from the disk, wherein each rotor blade has a leading edge and a blade tip surface; andwherein the annular shroud is disposed radially outside of the bladed rotor and comprises a primary segment (PS) and a forward segment (FS), and the primary segment and the forward segment extend around the entire circumference of the annular shroud; andwherein the primary segment has a PS forward end surface and a PS inner radial surface;
wherein the forward segment is disposed forward of the rotor blades and is configured to deflect core gas flow away from a blade tip gap disposed between the PS inner radial surface and the blade tip surface of each said rotor blade of the plurality of rotor blades;
and wherein the forward segment has an FS inner radial surface that extends between an FS forward end surface and an FS aft end surface.

2. The gas turbine engine of claim 1, wherein the forward segment extends from the PS inner radial surface radially inward a distance, such that the FS inner radial surface is radially aligned with blade tip surfaces of the rotor blades or disposed radially inward of the blade tip surfaces of the rotor blades.

3. The gas turbine engine of claim 2, wherein the FS inner radial surface is radially aligned with blade tip surfaces of the rotor blades at the leading edge of the respective rotor blades or is disposed radially inward of the blade tip surfaces of the rotor blades at the leading edge of the respective rotor blades.

4. The gas turbine engine of claim 2, wherein the FS forward end surface is disposed contiguous with the PS forward end surface.

5. The gas turbine engine of claim 4, wherein at least a portion of the FS forward end surface is co-planar with the PS forward end surface.

6. The gas turbine engine of claim 4, wherein the FS inner radial surface is disposed radially inward of the blade tip surfaces of the rotor blades.

7. The gas turbine engine of claim 6, wherein at least a portion of the FS inner radial surface is disposed parallel to the axial centerline of the gas turbine engine.

8. . (canceled)

9. The gas turbine engine of claim 1, wherein a portion of the FS aft end surface is contiguous with the PS inner radial surface.

10. The gas turbine engine of claim 4, wherein the FS inner radial surface is a peak contiguous with the FS forward end surface and an FS aft end surface.

11. The gas turbine engine of claim 1, wherein the shroud is a circumferentially segmented structure.

12. The gas turbine engine of claim 1, wherein the primary segment and the forward segment are integral with one another.

13. The gas turbine engine of claim 12, further comprising a vane stage disposed contiguous with the rotor stage and axially upstream of rotor stage, wherein the vane stage includes an outer platform disposed adjacent the shroud.

14. A turbine rotor stage having an axial centerline, comprising:a bladed rotor that includes a disk and a plurality of rotor blades extending radially outward from the disk, wherein each rotor blade has a leading edge and a blade tip surface; and an annular shroud disposed radially outside of the bladed rotor, wherein the annular shroud extends circumferentially around the bladed rotor, and includes a primary segment (PS) and a forward segment (FS), wherein the primary segment and the forward segment extend circumferentially around an entirety of the annular shroud, and the annular shroud is configured to be independent of an adjacent vane stage;wherein the primary segment has a PS forward end surface and a PS inner radial surface;wherein the forward segment has an FS inner radial surface that extends between an FS forward end surface and an FS aft end surface, and the forward segment extends from the PS inner radial surface radially inward a distance, such that the FS inner radial surface is radially aligned with blade tip surfaces of the rotor blades; andwherein at least a portion of the FS aft end surface comprises an arcuate portion.

15. The turbine rotor stage of claim 14, wherein the FS forward end surface is disposed contiguous with the PS forward end surface.

16. The turbine rotor stage of claim 15, wherein at least a portion of the FS forward end surface is co-planar with the PS forward end surface.

17. The turbine rotor stage of claim 16, wherein at least a portion of the FS inner radial surface is disposed parallel to the axial centerline.

18. The turbine rotor stage of claim 14, wherein the primary segment and the forward segment are integral with one another.

19. The turbine rotor stage of claim 14, wherein the shroud is a circumferentially segmented structure.

20-21. (canceled)
